(19) United States
(12) Patent Application Publication
(10) Pub. No.: US 2019/0122259 A1
(43) Pub. Date: Apr. 25, 2019

(54) MANAGING A FREQUENCY OF PRESENTATION OF A CONTENT ITEM ASSOCIATED WITH A CATEGORY WITHIN A HIERARCHICAL TAXONOMY TO A USER OF AN ONLINE SYSTEM

(71) Applicant: Facebook, Inc., Menlo Park, CA (US)

(72) Inventors: Braden Ford Bohrmann, San Francisco, CA (US); Ramnik Arora, Palo Alto, CA (US)

(21) Appl. No.: 15/793,626

(22) Filed: Oct. 25, 2017

(51) Int. Cl. G06Q 30/02

(52) U.S. Cl. CPC G06Q 30/0255; G06Q 30/0277; G06Q 30/0272; G06Q 30/0253

(57) ABSTRACT

An online system organizes content items based on assignments of the content items to categories within a hierarchical taxonomy. The online system tracks the progress of each online system user towards frequency caps applied to the categories. A user who reaches a frequency cap applied to a category is included in an exclusion group associated with the category, making them ineligible to be presented with content items associated with the category. Upon identifying an opportunity to present content to a viewing user, the online system determines whether the user is included in an exclusion group associated with a category. If not, the online system may present a content item associated with the category to the user, update the user's progress towards a frequency cap applied to the category, and determine whether to include the viewing user in the exclusion group based on the updated progress and the frequency cap.

### BACKGROUND

This disclosure relates generally to online systems, and more specifically to managing a frequency of presentation of a content item associated with a category within a hierarchical taxonomy to a user of an online system.

An online system allows its users to connect and communicate with other online system users. Users create profiles in the online system that are tied to their identities and include information about the users, such as interests and demographic information. The users may be individuals or entities such as corporations or charities. Because of the popularity of online systems and the significant amount of user-specific information maintained in online systems, an online system provides an ideal forum for content-providing users to share content by creating content items (e.g., advertisements) for presentation to additional online system users. For example, content-providing users may share photos or videos they have uploaded by creating content items that include the photos or videos that are presented to additional users to whom they are connected in the online system. By allowing content-providing users to create content items for presentation to additional online system users, an online system also provides abundant opportunities to persuade online system users to take various actions and/or to increase awareness about products, services, opinions, or causes among online system users. For example, if a content-providing user of the online system who volunteers for a non-profit organization creates a content item encouraging additional online system users to volunteer for the non-profit organization, the online system may present the content item to these additional online system users.

Conventionally, online systems generate revenue by displaying content to their users. For example, an online system may charge advertisers for each presentation of an advertisement to an online system user (i.e., each “impression”) or for each interaction with an advertisement by an online system user (e.g., each click on the advertisement, each purchase made as a result of clicking through the advertisement, etc.). Furthermore, by presenting content that encourages user engagement with online systems, online systems may increase the number of opportunities they have to generate revenue. For example, if an online system user scrolls through a newsfeed to view content that captures the user's interest, advertisements that are interspersed in the newsfeed also may be presented to the user.

To present content that encourages user engagement with online systems, online systems may select content items for presentation to online system users that are likely to be relevant to the users. Online systems may do so by selecting the content items based on targeting criteria associated with the content items that identify online system users who are likely to have an interest in the content items. For example, a content item maintained in the online system for bakeware may be associated with targeting criteria that identify online system users who have expressed an interest in baking (e.g., users whose user profiles indicate that the users' hobbies include baking, users whose profiles indicate that the users' occupations are related to baking, etc.). In this example, upon identifying an opportunity to present a content item to a user of the online system, the online system may select the content item for presentation to the user if attributes for the user satisfy one or more targeting criteria associated with the content item.

While targeting criteria allow online systems to select content items for presentation to online system users that are likely to be relevant to the users, selecting content items in this manner also may result in multiple presentations of the same or similar content items to the same online system user within a short period of time. For example, suppose that the online system presents a content item associated with shoes sold by a department store to an online system user in a newsfeed and that the user clicks on the content item. In this example, since the user expressed an interest in the shoes sold by the department store by clicking on the content item, in response to each subsequent request received from the user to access a web page of the online system, the online system may select from a set of content items for presentation to the user that are associated with the shoes and/or the department store. In the above example, by selecting from the same set of content items in response to subsequent requests received from the user to access the web pages of the online system, the online system is likely to present the same or similar content items to the user multiple times.

However, online system users who were unable to be persuaded to take actions associated with content items after multiple presentations of the content items within a short period of time are even less likely to be persuaded to do so in response to additional presentations of the same or similar content items within the same period of time. Furthermore, since these online system users are already aware of products, services, opinions, causes, etc. associated with the content items, by presenting the same or similar content items to these users, the online system may be wasting opportunities to present content items to the users in which the users are more likely to have an interest. Moreover, advertisers who are charged for each impression of an advertisement may be discouraged from advertising in an online system if their return on investment does not meet their expectations.

To prevent multiple presentations of the same content items to the same user of an online system within a short period of time, online systems may place frequency caps on content items. A frequency cap placed on a content item limits the frequency with which the content item may be presented to each online system user. For example, a frequency cap placed on a content item may limit the number of times the content item may be presented to each online system user within the same day or within the same week.

However, although frequency caps may help to limit the frequency with which the same content items are presented to the same online system user, frequency caps do not help to limit the frequency with which similar content items are presented to the same online system user. For example, if an advertiser has multiple advertising campaigns that each are associated with different advertisements, frequency caps may help to limit the frequency with which the same advertisements are presented to the same online system user, but do not help to limit the frequency with which a group of advertisements associated with the same advertising campaign are presented to the same user.

### SUMMARY

An online system, such as an online advertising system, enables content-providing users of the online system (e.g., advertisers) to provide content items (e.g., advertisements) to the online system for presentation to additional users of the online system. Content-providing users of the online system also may provide information describing hierarchical taxonomies to the online system, which may be used to organize content items received from the content-providing users. For example, if the online system receives information describing a hierarchical taxonomy from a content-providing user of the online system, content items received from the content-providing user may be organized based on categories within the hierarchical taxonomy with which the content items are associated.

A hierarchical taxonomy may include multiple levels arranged in order of increasing specificity and each level of the hierarchical taxonomy may include one or more categories. For example, information describing a hierarchical taxonomy received from a content-providing user of the online system may indicate that a highest level of the hierarchical taxonomy includes the broadest categories and that each lower level of the hierarchical taxonomy includes increasingly specific categories, such that a lowest level of the hierarchical taxonomy includes the most specific categories. In this example, if the content-providing user is a consumer goods corporation that owns several brands of different types of products, the information describing the hierarchical taxonomy also may indicate that a broadest category may be associated with all of the corporation's products. Furthermore, each category within a hierarchical taxonomy may include a set of more specific subcategories within a more specific level of the hierarchical taxonomy. In the above example, the broadest category may include a set of categories within a lower level of the hierarchical taxonomy, in which each category may be associated with a more specific type of the corporation's products (e.g., home products, food products, beauty products, etc.). Continuing with this example, each category also may include a set of even more specific subcategories within an even lower level of the hierarchical taxonomy, in which each subcategory may be associated with even more specific types of the corporation's products (e.g., types of home products, types of food products, types of beauty products, etc.).

In some embodiments, content items may be organized using a hierarchical taxonomy based on assignments of the content items to categories included in a most specific level of the hierarchical taxonomy. For example, suppose that the online system receives advertisements associated with various advertising campaigns from a content-providing user of the online system who is an advertiser. In this example, if information received from the content-providing user describing categories included in a most specific level of a hierarchical taxonomy indicates that the categories are associated with different advertising campaigns, each advertisement received from the content-providing user may be assigned to a category associated with an advertising campaign with which the advertisement is associated. Content items may be assigned to a category within a hierarchical taxonomy by the online system or by a content-providing user of the online system from whom the content items and information describing the hierarchical taxonomy were received. In the above example, the online system may assign the advertisements to the categories based on metadata associated with each advertisement identifying an advertising campaign associated with the advertisement and information received from the content-providing user describing the hierarchical taxonomy that identifies an advertising campaign associated with each category. Alternatively, in the above example, the advertisements may be assigned to the categories by the advertiser.

A content item that is assigned to a category within a hierarchical taxonomy may be associated with multiple categories of the hierarchical taxonomy. In some embodiments, a content item that is assigned to a category within a hierarchical taxonomy is associated with the category to which it is assigned, as well as each broader category that includes the category to which the content item is assigned. For example, if a content item is assigned to a first category included in a most specific level of a hierarchical taxonomy, the content item may be associated with the first category, as well as a second category included in a broader level of the hierarchical taxonomy that includes the first category. In this example, the content item also may be associated with a third category included in an even broader level of the hierarchical taxonomy that includes the second category, etc.

A content-providing user of the online system may manage the presentation of content items they have provided to the online system based on frequency caps that may be applied to one or more categories included in one or more levels of a hierarchical taxonomy. A frequency cap applied to a category may correspond to a maximum number of impressions of one or more content items associated with the category that may be achieved within a specified time period for each viewing user of the online system, a maximum number of installations of an application associated with one or more content items associated with the category that may occur within a specified time period for each viewing user of the online system, or any other suitable limitation that may be applied to one or more content items associated with a category. For example, suppose that a content-providing user of the online system has provided multiple content items associated with consumer electronics to the online system, as well as information describing a hierarchical taxonomy, in which a broadest level of the hierarchical taxonomy includes an electronics category that may be associated with all of the content items received from the content-providing user. In this example, the electronics category may include four subcategories of electronics (e.g., computers/tablets, mobile phones, televisions, and wearable technology) that are included in a more specific level of the hierarchical taxonomy. In the above example, a frequency cap of 11 impressions per week may be applied to the electronics category, a frequency cap of five impressions per week may be applied to the computers/tablets subcategory, a frequency cap of six impressions per week may be applied to the mobile phones subcategory, a frequency cap of three impressions per week may be applied to the televisions subcategory, and a frequency cap of five impressions per week may be applied to the wearable technology subcategory. Alternatively, in the above example, a default frequency cap of 19 impressions per week may be applied to the electronics category (e.g., based on a sum of the frequency caps applied to the four subcategories).

In some embodiments, a frequency cap to be applied to a category within a hierarchical taxonomy may be determined by the online system and/or by a content-providing user of the online system. For example, if the online system receives information describing a hierarchical taxonomy from a content-providing user of the online system, the online system also may receive information describing one or more frequency caps specified by the content-providing user to be applied to one or more categories within the hierarchical taxonomy. As an additional example, the online system may generate a graph using historical data by plotting a return on investment for impressions of content items associated with a category as a function of a number of impressions achieved by the content items. In this example, the online system may determine a frequency cap associated with the category that corresponds to the number of impressions achieved by the content items at which the return on investment begins to level off. Alternatively, in this example, the online system may present the graph to a content-providing user from whom the content items were received and allow the content-providing user to specify a frequency cap to be applied to the category based on the graph.

The online system may store various types of information associated with a hierarchical taxonomy. For example, the online system may store information describing a structure of a hierarchical taxonomy (e.g., a number of levels included in the hierarchical taxonomy, a number of categories included in each level, etc.). In the above example, the online system also may store information identifying a content-providing user of the online system from whom information describing the hierarchical taxonomy was received, a date and a time at which the information was received, information identifying content items assigned to one or more categories within the hierarchical taxonomy, information describing frequency caps applied to one or more categories within the hierarchical taxonomy, etc.

In some embodiments, a hierarchical taxonomy may be updated or modified. For example, suppose that a content-providing user of the online system from whom the online system receives information describing a hierarchical taxonomy is an advertiser. In this example, if different categories included in a most specific level of a hierarchical taxonomy are associated with different advertising campaigns, the content-providing user may modify the hierarchical taxonomy by adding categories associated with new advertising campaigns and deleting categories associated with old advertising campaigns. In such embodiments, once a hierarchical taxonomy has been updated or modified, information describing the updated or modified hierarchical taxonomy also may be stored in the online system.

The online system may track the progress of each viewing user of the online system towards a frequency cap applied to a category within a hierarchical taxonomy. In some embodiments, the online system may do so by maintaining a count that is associated with the category and each viewing user of the online system. For example, if a frequency cap of three impressions per week is applied to a category within a hierarchical taxonomy, the online system may maintain a weekly count of the number of impressions achieved by content items assigned to the category for each viewing user of the online system. In this example, when a first impression of a content item assigned to the category is achieved for a viewing user of the online system, the online system may increment a weekly count maintained in the online system that is associated with the category and the viewing user from zero to one. Continuing with this example, when a second impression of a content item assigned to the category is achieved for the viewing user, the online system may increment the weekly count from one to two, etc.

In some embodiments, when a viewing user of the online system progresses towards frequency caps applied to multiple categories within a hierarchical taxonomy, the online system may increment a count maintained in the online system that is associated with each category and the viewing user. For example, suppose that a frequency cap of five impressions per week is applied to a first category within a hierarchical taxonomy and that an additional frequency cap of six impressions per week is applied to a second category that includes the first category. In this example, in response to each impression achieved by a content item assigned to the first category for a viewing user of the online system, in addition to incrementing a weekly count maintained in the online system that is associated with the viewing user and the first category, the online system also may increment a weekly count maintained in the online system that is associated with the viewing user and the second category.

In some embodiments, a count maintained in the online system to track a progress of a viewing user of the online system towards a frequency cap applied to a category within a hierarchical taxonomy may be reset once a specified amount of time has elapsed. For example, suppose that a frequency cap of 10 impressions per week is applied to a category within a hierarchical taxonomy. In the above example, since the frequency cap specifies a maximum number of impressions per week, at the end of the week, the online system may reset a weekly count maintained in the online system that is associated with the category and a viewing user of the online system to zero.

If a viewing user of the online system reaches a frequency cap applied to a category within a hierarchical taxonomy, the online system may include the viewing user in an exclusion group associated with the category. Viewing users of the online system included in an exclusion group associated with a category are not eligible to be presented with content items associated with the category (e.g., content items assigned to the category and/or content items assigned to one or more subcategories included in the category). In some embodiments, the online system may include a viewing user in an exclusion group associated with a category by adding user-identifying information for the viewing user (e.g., a username or a user identification number) to a list maintained in the online system that corresponds to the exclusion group associated with the category. For example, suppose a frequency cap of two impressions per week is applied to a category within a hierarchical taxonomy. In this example, once a weekly count maintained in the online system that is associated with the category and a viewing user is incremented to two, user-identifying information for the viewing user may be added to a list corresponding to an exclusion group associated with the category identifying online system users who may not be presented with content items assigned to the category. In some embodiments, a viewing user may be removed from an exclusion group (e.g., once a specified amount of time has elapsed). In the above example, at the end of the week, the viewing user is removed from the exclusion group by removing the user-identifying information for the viewing user from the list.

Upon identifying an opportunity to present a content item to a viewing user of the online system, the online system may determine whether the viewing user is included in one or more exclusion groups associated with one or more categories within a hierarchical taxonomy. For example, the online system may determine that a viewing user is not included in any exclusion groups associated with one or more categories within a hierarchical taxonomy, in which none of the categories are included in broader categories within the hierarchical taxonomy that are associated with exclusion groups that include the viewing user. The online system may determine whether the viewing user is included in an exclusion group associated with a category by determining whether user-identifying information for the viewing user is included in a list maintained in the online system that corresponds to an exclusion group associated with the category. Furthermore, the online system may determine whether the viewing user is included in exclusion groups associated with categories within the hierarchical taxonomy by examining the exclusion groups associated with the broadest categories first, by examining the exclusion groups associated with the most specific categories first, or by examining the exclusion groups associated with the categories in any other suitable order.

Once the online system has determined that the viewing user is not included in an exclusion group associated with a category within the hierarchical taxonomy, the online system may identify one or more content items associated with the category as candidate content items that are eligible to be presented to the viewing user. For example, the online system may identify all content items associated with categories that are not associated with exclusion groups that include a viewing user as candidate content items that are eligible to be presented to the viewing user. In some embodiments, the online system may identify the candidate content items based on additional factors as well (e.g., targeting criteria specifying attributes for online system users eligible to be presented with the content items). For example, once the online system has determined that a viewing user of the online system is not included in an exclusion group associated with a category within a hierarchical taxonomy, the online system may identify only content items associated with the category that also are associated with targeting criteria (e.g., age, gender, geographic location, etc.) satisfied by the viewing user as candidate content items that are eligible to be presented to the viewing user.

In alternative embodiments, the online system may perform the steps described above in a different order. For example, the online system may first identify one or more content items that are associated with targeting criteria that are satisfied by a viewing user. In this example, for each content item identified by the online system, the online system may determine whether the viewing user is included in an exclusion group associated with a category with which the content item is associated. Continuing with the above example, if the viewing user is not included in the exclusion group associated with the category, the online system may identify the content item associated with the category to be a candidate content item eligible to be presented to the viewing user.

Once the online system has identified a set of candidate content items eligible to be presented to the viewing user, the online system may select one or more of the candidate content items for presentation to the viewing user. In some embodiments, the online system may rank the candidate content items based at least in part on a value associated with each candidate content item and select one or more content items for presentation to the viewing user based at least in part on the ranking. For example, the online system may rank the candidate content items based at least in part on an affinity score computed by the online system indicating a predicted affinity of a viewing user for the candidate content item, in which candidate content items having higher affinity scores are ranked higher than candidate content items having lower affinity scores. In this example, if one or more of the candidate content items are advertisements, the online system also or alternatively may rank the candidate content items based at least in part on a bid amount associated with each advertisement, in which advertisements associated with higher bid amounts are ranked higher than advertisements associated with lower bid amounts. In the above examples, the online system may select one or more content items having the highest rankings for presentation to the viewing user and present the selected content items to the viewing user (e.g., in a newsfeed).

If a content item presented to the viewing user is associated with one or more categories within the hierarchical taxonomy to which frequency caps have been applied, upon receiving information indicating the viewing user's progress towards the frequency cap has changed, the online system may update the progress of the viewing user towards a frequency cap applied to each category. For example, if a frequency cap applied to a category corresponds to a maximum number of impressions of content items assigned to the category, upon presenting a content item assigned to the category to a viewing user of the online system, the online system may increment a count maintained in the online system that is associated with the viewing user and the category. In the above example, if a frequency cap also is applied to any broader categories that include the category to which the content item has been assigned, the online system also may increment a count maintained in the online system that is associated with the viewing user and each of these broader categories.

In some embodiments, upon updating the progress of the viewing user towards a frequency cap applied to a category, the online system may determine whether the viewing user should be added to an exclusion group associated with the category. If so, the online system may include the viewing user in the exclusion group, as described above. For example, if a frequency cap of 30 impressions per month is applied to a category and the online system increments a monthly count of the number of impressions achieved by content items assigned to the category maintained for a viewing user, the online system may compare the monthly count to a value specified by the frequency cap. In this example, the online system may include the viewing user in an exclusion group associated with the category if the monthly count is at least 30.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for managing a frequency of presentation of a content item associated with a category within a hierarchical taxonomy to a user of an online system, in accordance with an embodiment.

FIG. 4 is a conceptual diagram of categories within levels of a hierarchical taxonomy associated with a content-providing user of an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

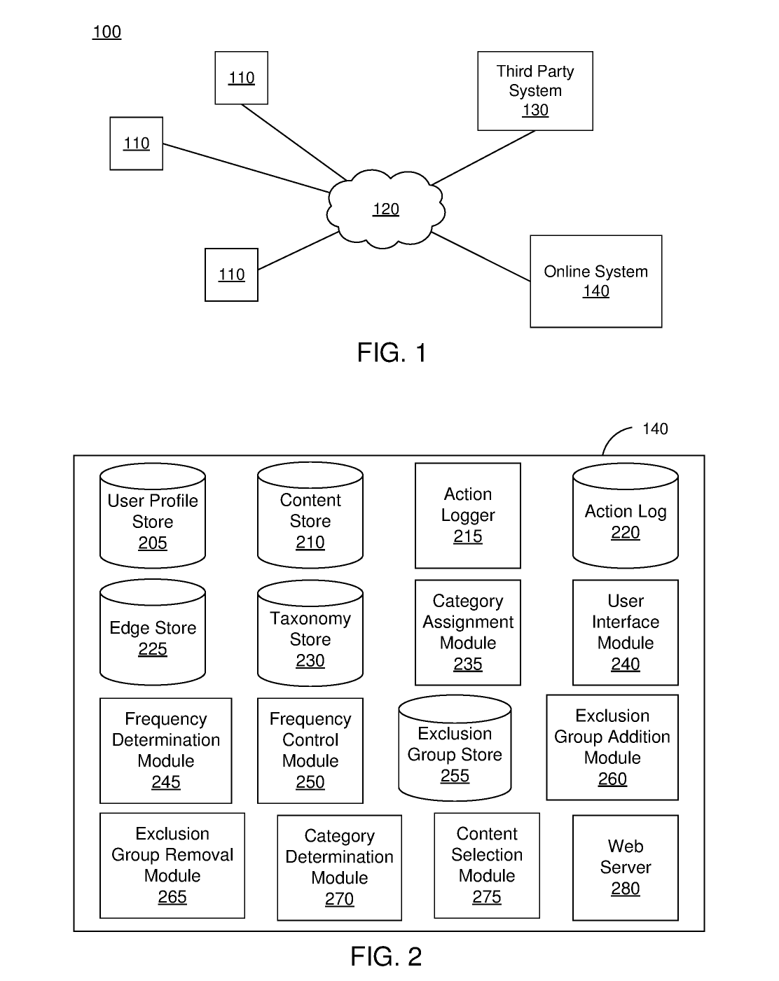

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third-party systems 130 may be coupled to the network 120 for communicating with the online system 140, which is further described below in conjunction with FIG. 2. In one embodiment, a third-party system 130 is an application provider communicating information describing applications for execution by a client device 110 or communicating data to client devices 110 for use by an application executing on the client device 110. In other embodiments, a third-party system 130 (e.g., a content publisher) provides content or other information for presentation via a client device 110. A third-party system 130 also may communicate information to the online system 140, such as advertisements, content, or information about an application provided by the third-party system 130.

FIG. 2 is a block diagram of an architecture of the online system 140. The online system 140 shown in FIG. 2 includes a user profile store 205, a content store 210, an action logger 215, an action log 220, an edge store 225, a taxonomy store 230, a category assignment module 235, a user interface module 240, a frequency determination module 245, a frequency control module 250, an exclusion group store 255, an exclusion group addition module 260, an exclusion group removal module 265, a category determination module 270, a content selection module 275, and a web server 280. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes for the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

The user profile store 205 also may store information describing a progress of each viewing user of the online system 140 towards a frequency cap applied to a category within a hierarchical taxonomy. In some embodiments, information describing a viewing user's progress towards a frequency cap may be stored as a count. For example, if a frequency cap corresponds to a maximum number of impressions of content items associated with a category that may be achieved within a day, a viewing user's progress towards the frequency cap may be stored in the user profile store 205 as a daily count. In this example, a value stored in the daily count corresponds to a number of impressions of content items associated with the category that have been achieved during the same day for the viewing user. A count may be stored in association with information identifying a viewing user and a category associated with the count. For example, if a count tracks a viewing user's progress towards a frequency cap applied to a category within a hierarchical taxonomy, the count may be stored in the user profile store 205 in association with a user profile of the viewing user and an identifier that uniquely identifies the hierarchical taxonomy and the category within the hierarchical taxonomy.

While user profiles in the user profile store 205 are frequently associated with individuals, allowing individuals to interact with each other via the online system 140, user profiles also may be stored for entities such as businesses or organizations. This allows an entity to establish a presence in the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

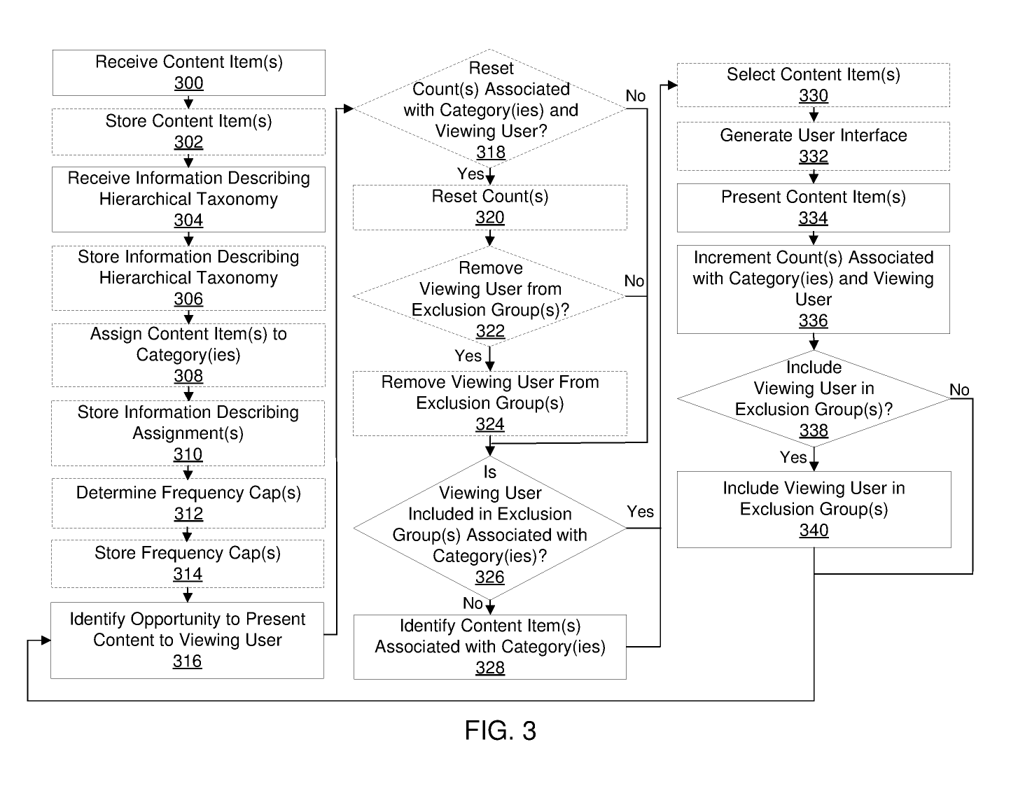

The content store 210 may store (e.g., as shown in step 302 of FIG. 3) objects representing content items in association with information associated with one or more categories within a hierarchical taxonomy associated with the content items. A content item may be associated with a category within a hierarchical taxonomy to which the content item is assigned, as well as each broader category that includes the category to which the content item is assigned. Information stored in association with an object representing a content item associated with a category within a hierarchical taxonomy may include information identifying a content-providing user of the online system 140 from whom the content item/information describing the hierarchical taxonomy was received, information identifying the hierarchical taxonomy, information identifying the category, information describing a frequency cap applied to the category, etc. For example, an object representing a content item may be stored in the content store 210 in association with an identifier (e.g., a username or an identification number) associated with a content-providing user of the online system 140 from whom the content item was received, an identifier associated with a hierarchical taxonomy received from the content-providing user, names of one or more categories within the hierarchical taxonomy that are associated with the content item (e.g., a category to which the content item is assigned and one or more broader categories that include this category), and information describing a frequency cap applied to each of the categories associated with the content item.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions in the online system 140, as well as actions in the third-party system 130 that communicate information to the online system 140. Users may interact with various objects in the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects in the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements in the online system 140 as well as with other applications operating in the online system 140. In some embodiments, data from the action log 220 is used to infer interests or preferences of a user, augmenting the interests included in the user's user profile and allowing a more complete understanding of user preferences.

The action log 220 also may store user actions taken on a third-party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third-party system 130, including webpage viewing histories, advertisements that were engaged, purchases made, and other patterns from shopping and buying. Additionally, actions a user performs via an application associated with a third-party system 130 and executing on a client device 110 may be communicated to the action logger 215 for storing in the action log 220 by the application for recordation and association with the user by the online system 140.

In one embodiment, the edge store 225 stores information describing connections between users and other objects in the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page in the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 2012/0166532 A1, published on Jun. 28, 2012), U.S. patent application Ser. No. 13/690,254 (U.S. Pat. No. 9,070,141, issued on Jun. 30, 2015), filed on Nov. 30, 2012, U.S. patent application Ser. No. 13/689,969, filed on Nov. 30, 2012 (U.S. Pat. No. 9,317,812, issued on Apr. 19, 2016), and U.S. patent application Ser. No. 13/690,088, filed on Nov. 30, 2012 (U.S. Publication No. US 2014/0156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The taxonomy store 230 stores (e.g., as shown in step 306 of FIG. 3) information associated with one or more hierarchical taxonomies. In some embodiments, information stored in the taxonomy store 230 includes information describing one or more hierarchical taxonomies received from one or more content-providing users of the online system 140. Information describing a hierarchical taxonomy received from a content-providing user of the online system 140 may describe levels of the hierarchical taxonomy. For example, information describing a hierarchical taxonomy may indicate a number of levels included in the hierarchical taxonomy. Levels of a hierarchical taxonomy may be arranged in order of increasing specificity. In the above example, the information describing the hierarchical taxonomy also may indicate that a highest level of the hierarchical taxonomy includes the broadest categories and that each lower level of the hierarchical taxonomy includes increasingly specific categories, such that a lowest level of the hierarchical taxonomy includes the most specific categories.

Information describing a hierarchical taxonomy received from a content-providing user of the online system 140 also may describe one or more categories included in each level of the hierarchical taxonomy. For example, information describing a hierarchical taxonomy may indicate a number of categories included in each level of the hierarchical taxonomy and a name or other identifier associated with each category. Furthermore, information describing each category within a hierarchical taxonomy may describe a set of more specific subcategories within a more specific level of the hierarchical taxonomy. For example, suppose that a content-providing user of the online system 140 from whom the online system 140 has received information describing a hierarchical taxonomy is an entity, such as a consumer goods corporation that owns several brands of different types of products. In this example, the hierarchical taxonomy may have a highest level that includes a broadest category that may be associated with all of the corporation's products. Furthermore, in this example, the broadest category may include a set of categories within a lower level of the hierarchical taxonomy, in which each category may be associated with a more specific type of the corporation's products (e.g., automobile care products, pet products, beauty products, etc.). Continuing with this example, each category also may include a set of even more specific subcategories within an even lower level of the hierarchical taxonomy, in which each subcategory may be associated with even more specific types of the corporation's products (e.g., types of automobile care products, types of pet products, types of beauty products, etc.).

In some embodiments, the taxonomy store 230 may store information describing a hierarchical taxonomy in association with various additional types of information associated with the hierarchical taxonomy. Information associated with a hierarchical taxonomy may include information identifying a content-providing user of the online system 140 from whom information describing the hierarchical taxonomy was received, a date and a time at which the information was received, information identifying the hierarchical taxonomy, information identifying each content item assigned to a category within the hierarchical taxonomy, information describing a frequency cap to be applied to a category within the hierarchical taxonomy, etc. For example, information describing a hierarchical taxonomy received from a content-providing user of the online system 140 may be stored in the taxonomy store 230 in association with a username of the content-providing user, a name assigned to the hierarchical taxonomy by the content-providing user, identifiers associated with content items assigned to one or more categories within the hierarchical taxonomy, and information describing a frequency cap to be applied to each category within the hierarchical taxonomy.

In some embodiments, information that may be associated with a hierarchical taxonomy also may describe associations between one or more content items and one or more categories within the hierarchical taxonomy. As described above in conjunction with the content store 210, in some embodiments, a content item that is assigned to a category within a hierarchical taxonomy may be associated with multiple categories of the hierarchical taxonomy (e.g., the category to which it is assigned, as well as each broader category that includes the category to which the content item is assigned). For example, if a content item is assigned to a first category included in a most specific level of a hierarchical taxonomy, the content item may be associated with the first category as well as a second category included in a broader level of the hierarchical taxonomy that includes the first category. In this example, the content item also may be associated with a third category included in an even broader level of the hierarchical taxonomy that includes the second category, etc. In the above example, information describing the associations between the content item and each of the categories may be stored in the taxonomy store 230 in association with information describing the hierarchical taxonomy.

In some embodiments, information describing updates or modifications to a hierarchical taxonomy also may be stored in the taxonomy store 230. For example, suppose that a content-providing user of the online system 140 from whom the online system 140 has received information describing a hierarchical taxonomy is an advertiser. In this example, if different categories included in a most specific level of the hierarchical taxonomy are associated with different advertising campaigns, the content-providing user may modify the hierarchical taxonomy by adding categories associated with new advertising campaigns and deleting categories associated with old advertising campaigns. Continuing with this example, information describing the previous version of the hierarchical taxonomy may be replaced by information describing the updated version of the hierarchical taxonomy in the taxonomy store 230. Alternatively, in the above example, the information describing the previous version of the hierarchical taxonomy and the updated version of the hierarchical taxonomy both may be stored in the taxonomy store 230, such that the information describing each version of the hierarchical taxonomy may be stored in association with a date and a time that it was received from the content-providing user. The taxonomy store 230 is further described below in conjunction with FIG. 3.

The category assignment module 235 assigns (e.g., as shown in step 308 of FIG. 3) content items to one or more categories within a hierarchical taxonomy. In some embodiments, after the online system 140 has received information describing a hierarchical taxonomy from a content-providing user of the online system 140, the category assignment module 235 may organize content items also received from the content-providing user by assigning them to one or more categories included in a most specific level of the hierarchical taxonomy. For example, suppose that the online system 140 receives advertisements associated with various advertising campaigns from a content-providing user of the online system 140 who is an advertiser. In this example, if information received from the content-providing user indicates that categories included in a most specific level (e.g., a lowest level) of a hierarchical taxonomy are associated with different advertising campaigns, the category assignment module 235 may assign each advertisement received from the content-providing user to a category associated with an advertising campaign with which the advertisement is associated. In the above example, the category assignment module 235 may assign the advertisements to the categories based on metadata associated with each advertisement identifying an advertising campaign associated with the advertisement and information describing the hierarchical taxonomy (e.g., stored in the taxonomy store 230) that identifies an advertising campaign associated with each category. The functionality of the category assignment module 235 is further described below in conjunction with FIG. 3.

The user interface module 240 may generate a graph that may be used to determine a frequency cap to be applied to a category within a hierarchical taxonomy. In some embodiments, the user interface module 240 may generate the graph based on historical data associated with one or more content items associated with the category that previously were presented to viewing users of the online system 140. The historical data may describe previous impressions of content items, previous clicks on content items, previous installations of applications associated with content items, or any other suitable historical data that may be associated with content items. For example, the user interface module 240 may generate a graph that plots a return on investment for impressions of content items associated with a category as a function of a number of impressions achieved by the content items.

The user interface module 240 also may generate (e.g., as shown in step 332 of FIG. 3) a user interface in which one or more content items selected for presentation to a viewing user of the online system 140 may be presented. In some embodiments, the user interface generated by the user interface module 240 may include a feed of content items that includes one or more content items selected for presentation to a viewing user of the online system 140. For example, the user interface module 240 may generate a newsfeed associated with a user profile of a viewing user of the online system 140. In this example, the newsfeed may include multiple content items (e.g., advertisements) selected for presentation to the viewing user. The user interface generated by the user interface module 240 also may include a set of interactive elements (e.g., buttons) that each correspond to an option associated with a content item that may be selected by a viewing user of the online system 140. Examples of options associated with a content item that may be selected by a viewing user include an option to express a preference for a content item, an option to share the content item with additional online system users, and an option to comment on the content item. For example, if a viewing user of the online system 140 selects an option to share a content item presented to the viewing user, the content item may be presented to additional users of the online system 140 to whom the viewing user is connected in the online system 140. The functionality of the user interface module 240 is further described below in conjunction with FIG. 3.

The frequency determination module 245 determines (e.g., as shown in step 312 of FIG. 3) one or more frequency caps to be applied to one or more categories within a hierarchical taxonomy. Frequency caps applied to categories of hierarchical taxonomies allow content-providing users of the online system 140 to manage the presentation of content items they have provided to the online system 140. A frequency cap applied to a category may correspond to a maximum number of impressions of one or more content items associated with the category that may be achieved within a specified time period for each viewing user of the online system 140, a maximum number of installations of an application associated with one or more content items associated with the category that may occur within a specified time period for each viewing user of the online system 140, or any other suitable limitation that may be applied to one or more content items associated with a category.

Frequency caps may be applied to multiple categories included in different levels of a hierarchical taxonomy. For example, suppose that a content-providing user of the online system 140 has provided multiple content items associated with repair services to the online system 140, as well as information describing a hierarchical taxonomy, in which a broadest level of the hierarchical taxonomy includes a repair services category that may be associated with all of the content items received from the content-providing user. In this example, the repair services category may include four subcategories of repair services (e.g., roofing repair services, plumbing repair services, electrical repair services, and heating/cooling repair services) that are included in a more specific level of the hierarchical taxonomy. In the above example, a frequency cap of 13 impressions per week may be applied to the repair services category, a frequency cap of five impressions per week may be applied to the roofing repair services subcategory, a frequency cap of six impressions per week may be applied to the plumbing repair services subcategory, a frequency cap of three impressions per week may be applied to the electrical repair services subcategory, and a frequency cap of five impressions per week may be applied to the heating/cooling repair services subcategory. Alternatively, in the above example, a default frequency cap of 19 impressions per week may be applied to the repair services category (e.g., based on a sum of the frequency caps applied to the four subcategories).

In some embodiments, a frequency cap to be applied to a category within a hierarchical taxonomy may be determined by the frequency determination module 245. For example, as described above, the user interface module 240 may generate a graph that plots a return on investment for impressions of content items associated with a category as a function of a number of impressions achieved by the content items. In this example, the frequency determination module 245 may determine a frequency cap associated with the category that corresponds to the number of impressions achieved by the content items at which the return on investment begins to level off. In various embodiments, a frequency cap to be applied to a category within a hierarchical taxonomy also or alternatively may be determined by a content-providing user of the online system 140. In the above example, the online system 140 may present the graph to a content-providing user from whom the content items were received and allow the content-providing user to specify a frequency cap to be applied to the category based on the graph. As an additional example, if the online system 140 receives information describing a hierarchical taxonomy from a content-providing user of the online system 140, the online system 140 also may receive information describing one or more frequency caps specified by the content-providing user to be applied to one or more categories within the hierarchical taxonomy. The functionality of the frequency determination module 245 is further described below in conjunction with FIG. 3.

The frequency control module 250 tracks the progress of each viewing user of the online system 140 towards one or more frequency caps applied to one or more categories within a hierarchical taxonomy. The frequency control module 250 may track the progress of a viewing user of the online system 140 towards a frequency cap applied to a category by updating a count that is associated with the category and the viewing user. In some embodiments, the frequency control module 250 may increment (e.g., as shown in step 336 of FIG. 3) a count associated with a category and a viewing user upon each presentation of a content item associated with the category to the viewing user. For example, if a frequency cap of three impressions per week is applied to a category within a hierarchical taxonomy, the online system 140 may maintain a weekly count of the number of impressions achieved by content items assigned to the category for each viewing user of the online system 140 (e.g., in the user profile store 205). In this example, when a first impression of a content item assigned to the category is achieved for a viewing user of the online system 140, the frequency control module 250 may increment a weekly count maintained in the online system 140 that is associated with the category and the viewing user from zero to one. Continuing with this example, when a second impression of a content item assigned to the category is achieved for the viewing user, the frequency control module 250 may increment the weekly count from one to two, etc.

In various embodiments, if a content item presented to a viewing user is associated with multiple categories within a hierarchical taxonomy to which frequency caps have been applied, upon presenting the content item to the viewing user, the frequency control module 250 may track the progress of the viewing user towards a frequency cap applied to each category. For example, suppose that a frequency cap of five impressions per week is applied to a first category within a hierarchical taxonomy and that an additional frequency cap of six impressions per week is applied to a second category that includes the first category. In this example, in response to each impression achieved by a content item assigned to the first category for a viewing user of the online system 140, in addition to incrementing a weekly count maintained in the online system 140 that is associated with the viewing user and the first category, the frequency control module 250 also may increment a weekly count maintained in the online system 140 that is associated with the viewing user and the second category.

The frequency control module 250 also may determine (e.g., as shown in step 318 of FIG. 3) whether to reset a count associated with a category within a hierarchical taxonomy and a viewing user of the online system 140. In some embodiments, the frequency control module 250 may determine whether to reset a count associated with a category and a viewing user of the online system 140 based on whether an amount of time specified by a frequency cap applied to the category has elapsed. For example, suppose that a frequency cap applied to a category describes a specified number of impressions of content items associated with the category that may be achieved within a week for each viewing user of the online system 140. In this example, a weekly count associated with the category may be stored in association with a user profile of a viewing user in the user profile store 205 that describes a progress of the viewing user towards the frequency cap. Continuing with this example, since the frequency cap specifies a maximum number of impressions per week, if the week began at 12:00 AM on a Sunday, at the end of the week (e.g., at 12:00 AM on the following Sunday), the frequency control module 250 may determine that the weekly count associated with the category and the viewing user should be reset. In the above example, prior to the end of the week, the frequency control module 250 may determine that the weekly count associated with the category and the viewing user should not be reset. Alternatively, in the above example, the frequency control module 250 may determine that the weekly count should be reset only after a week has elapsed from the time that the count was incremented from zero to one.

In some embodiments, upon determining that a count associated with a category and a viewing user of the online system 140 should be reset, the frequency control module 250 may reset (e.g., as shown in step 320 of FIG. 3) the count. For example, suppose that a frequency cap of 10 impressions per week is applied to a category within a hierarchical taxonomy. In the above example, once the frequency control module 250 has determined that a weekly count maintained in the online system 140 that is associated with a viewing user and the category should be reset, the frequency control module 250 may reset the count to zero. The functionality of the frequency control module 250 is further described below in conjunction with FIG. 3.

The exclusion group store 255 stores information describing viewing users of the online system 140 included in one or more exclusion groups associated with one or more categories within a hierarchical taxonomy. Viewing users included in an exclusion group associated with a category within a hierarchical taxonomy are not eligible to be presented with content items associated with the category (e.g., content items assigned to the category and/or content items assigned to one or more subcategories included in the category). For example, if a viewing user is included in an exclusion group associated with a category to which content items are assigned, the viewing user is not eligible to be presented with the content items. Alternatively, in the above example, if the category includes multiple subcategories to which content items are assigned, the viewing user is not eligible to be presented with the content items assigned to the subcategories.

In some embodiments, a viewing user is included in an exclusion group associated with a category within a hierarchical taxonomy if user-identifying information for the viewing user is included in a list maintained in the exclusion group store 255 that corresponds to an exclusion group associated with the category. For example, suppose that a list corresponding to an exclusion group associated with each category within a hierarchical taxonomy is stored in the exclusion group store 255. In this example, a viewing user of the online system 140 is included in an exclusion group associated with a category if user-identifying information for the viewing user is included in a list corresponding to the exclusion group associated with the category. The exclusion group store 255 is further described below in conjunction with FIG. 3.

The exclusion group addition module 260 determines (e.g., as shown in step 338 of FIG. 3) whether to include a viewing user of the online system 140 in an exclusion group associated with a category within a hierarchical taxonomy. The exclusion group addition module 260 may determine that a viewing user of the online system 140 should be included in an exclusion group associated with a category if the viewing user reaches a frequency cap applied to the category. In some embodiments, the exclusion group addition module 260 may determine whether to include a viewing user of the online system 140 in an exclusion group associated with a category by comparing a count associated with the category and the viewing user to a value specified by a frequency cap applied to the category. For example, if a frequency cap of 30 impressions per month is applied to a category and the frequency control module 250 increments a monthly count of the number of impressions achieved by content items assigned to the category maintained for a viewing user of the online system 140, the exclusion group addition module 260 may compare the monthly count to a value specified by the frequency cap. In this example, the exclusion group addition module 260 may determine that the viewing user should be included in an exclusion group associated with the category if the monthly count is at least 30. Conversely, in this example, the exclusion group addition module 260 may determine that the viewing user should not be included in an exclusion group associated with the category if the monthly count is less than 30.

In some embodiments, upon determining that a viewing user of the online system 140 should be included in an exclusion group associated with a category within a hierarchical taxonomy, the exclusion group addition module 260 may include (e.g., as shown in step 340 of FIG. 3) the viewing user in the exclusion group. In some embodiments, the exclusion group addition module 260 may include a viewing user in an exclusion group associated with a category by adding user-identifying information for the viewing user (e.g., a username or a user identification number) to a list maintained in the online system 140 that corresponds to the exclusion group associated with the category (e.g., in the exclusion group store 255). For example, if a frequency cap of two impressions per week is applied to a category within a hierarchical taxonomy, once a count maintained in the online system 140 that is associated with the category and a viewing user is incremented to two, the exclusion group addition module 260 may add user-identifying information for the viewing user to a list corresponding to an exclusion group associated with the category maintained in the exclusion group store 255. The functionality of the exclusion group addition module 260 is further described below in conjunction with FIG. 3.

The exclusion group removal module 265 determines (e.g., as shown in step 322 of FIG. 3) whether to remove a viewing user of the online system 140 from an exclusion group associated with a category within a hierarchical taxonomy. In some embodiments, the exclusion group removal module 265 may determine whether to remove a viewing user of the online system 140 from an exclusion group based on whether an amount of time specified by a frequency cap applied to the category has elapsed. For example, suppose that a frequency cap associated with a category describes a specified number of impressions of content items associated with the category that may be achieved within 30 days. In this example, suppose also that a 30-day count stored in association with a user profile of a viewing user in the user profile store 205 describing a progress of the viewing user towards the frequency cap indicates that the viewing user has reached the frequency cap associated with the category and that the exclusion group addition module 260 has included the viewing user in an exclusion group associated with the category. Continuing with this example, if the 30 days began at 12:00 AM on the first day of a month, at the end of the 30 days (e.g., at 12:00 AM on the 31^{st} day), the exclusion group removal module 265 may determine that the viewing user should be removed from the exclusion group. Conversely, in this example, prior to the end of the 30 days, the exclusion group removal module 265 may determine that the viewing user should not be removed from the exclusion group. Alternatively, in the above example, the exclusion group removal module 265 may determine that the viewing user should be removed from the exclusion group only after 30 days have elapsed from the time that the 30-day count was incremented from zero to one.

In alternative embodiments, the exclusion group removal module 265 may determine whether to remove a viewing user of the online system 140 from an exclusion group associated with a category based on the progress of the viewing user towards a frequency cap applied to the category. For example, if a viewing user of the online system 140 is included in an exclusion group associated with a category, the exclusion group removal module 265 may periodically compare a count maintained in the online system 140 associated with the viewing user and the category to a value specified by a frequency cap applied to the category. In this example, the exclusion group removal module 265 may determine that the viewing user should be removed from the exclusion group associated with the viewing user and the category if the count is less than the value specified by the frequency cap applied to the category. In contrast, in the above example, the exclusion group removal module 265 may determine that the viewing user should not be removed from the exclusion group associated with the viewing user and the category if the count is equal to or greater than the value specified by the frequency cap applied to the category. As an additional example, the exclusion group removal module 265 may determine that a viewing user of the online system 140 should be removed from an exclusion group associated with a category only when the frequency control module 250 resets a count maintained in the online system 140 associated with the viewing user and the category.

Upon determining that a viewing user of the online system 140 should be removed from an exclusion group associated with a category within a hierarchical taxonomy, the exclusion group removal module 265 may remove (e.g., as shown in step 324 of FIG. 3) the viewing user from the exclusion group. In some embodiments, the exclusion group removal module 265 may remove a viewing user from an exclusion group associated with a category by removing user-identifying information for the viewing user (e.g., a username or a user identification number) from a list maintained in the online system 140 that corresponds to the exclusion group associated with the category (e.g., in the exclusion group store 255). For example, suppose that a viewing user of the online system 140 is included in an exclusion group associated with a category within a hierarchical taxonomy. In this example, if a count is maintained in the online system 140 to track the progress of the viewing user towards a frequency cap applied to the category, once the count is less than a value specified by the frequency cap, the exclusion group removal module 265 may remove the viewing user from the exclusion group by removing user-identifying information for the viewing user from a list corresponding to the exclusion group associated with the category maintained in the exclusion group store 255. The functionality of the exclusion group removal module 265 is further described below in conjunction with FIG. 3.

The category determination module 270 determines (e.g., as shown in step 326 of FIG. 3) if a viewing user of the online system 140 is included in one or more exclusion groups associated with one or more categories within a hierarchical taxonomy. In some embodiments, the category identification module 270 determines whether a viewing user of the online system 140 is included in exclusion groups associated with categories included in different levels of a hierarchical taxonomy. For example, the category determination module 270 may determine that a viewing user is not included in any exclusion groups associated with one or more categories within a hierarchical taxonomy, in which none of the categories are included in broader categories within the hierarchical taxonomy that are associated with exclusion groups that include the viewing user.

In some embodiments, the category determination module 270 may determine whether a viewing user is included in an exclusion group associated with a category based on information stored in the exclusion group store 255. For example, the category determination module 270 may access the exclusion group store 255 and determine whether a viewing user of the online system 140 is included in an exclusion group associated with a category based on whether user-identifying information for the viewing user is included in a list corresponding to the exclusion group associated with the category. In this example, the category determination module 270 may determine that the viewing user is included in the exclusion group if user-identifying information for the viewing user is included in the list corresponding to the exclusion group associated with the category. Conversely, in this example, the category determination module 270 may determine that the viewing user is not included in the exclusion group if user-identifying information for the viewing user is not included in the list corresponding to the exclusion group associated with the category. The category determination module 270 may determine whether a viewing user is included in exclusion groups associated with categories within a hierarchical taxonomy by examining the exclusion groups associated with the broadest categories first, by examining the exclusion groups associated with the most specific categories first, or by examining exclusion groups associated with categories in any other suitable order. The functionality of the category determination module 270 is further described below in conjunction with FIG. 3.

The content selection module 275 identifies (e.g., as shown in step 328 of FIG. 3) a set of candidate content items eligible for presentation to a viewing user of the online system 140. In some embodiments, once the category determination module 270 has determined that a viewing user of the online system 140 is not included in one or more exclusion groups associated with one or more categories within a hierarchical taxonomy, the content selection module 275 may then identify a set of content items associated with the categories as candidate content items that are eligible for presentation to the viewing user. For example, the content selection module 275 may access the taxonomy store 230 or the content store 210 and identify all content items associated with categories that are not associated with exclusion groups that include a viewing user of the online system 140 as candidate content items eligible to be presented to the viewing user. In various embodiments, the content selection module 275 may identify a set of candidate content items based on additional factors as well (e.g., targeting criteria specifying attributes for online system users eligible to be presented with the content items). For example, once the category determination module 270 has determined that a viewing user of the online system 140 is not included in one or more exclusion groups associated with one or more categories within a hierarchical taxonomy, the content selection module 275 may identify only content items associated with the categories that are associated with targeting criteria (e.g., age, gender, geographic location, etc.) satisfied by the viewing user as candidate content items.

In alternative embodiments, the content selection module 275 may perform the steps described above in a different order. For example, the content selection module 275 may first identify one or more content items that are associated with targeting criteria that are satisfied by a viewing user. In this example, for each content item identified by the content selection module 275, the category determination module 270 may determine whether the viewing user is included in an exclusion group associated with a category with which the content item is associated. Continuing with the above example, if the viewing user is not included in the exclusion group associated with the category, the content selection module 275 may identify the content item associated with the category to be a candidate content item eligible to be presented to the viewing user.

Once the content selection module 275 has identified a set of candidate content items eligible to be presented to a viewing user of the online system 140, the content selection module 275 may select (e.g., as shown in step 330 of FIG. 3) one or more of the candidate content items for presentation to the viewing user. In some embodiments, the content selection module 275 may rank the candidate content items based at least in part on a value associated with each candidate content item and select one or more content items for presentation to the viewing user based at least in part on the ranking. For example, the content selection module 275 may rank candidate content items based at least in part on an affinity score computed by the online system 140 indicating a predicted affinity of a viewing user for the candidate content item, in which candidate content items having higher affinity scores are ranked higher than candidate content items having lower affinity scores. In this example, if one or more of the candidate content items are advertisements, the content selection module 275 also or alternatively may rank the candidate content items based at least in part on a bid amount associated with each advertisement, in which advertisements associated with higher bid amounts are ranked higher than advertisements associated with lower bid amounts. In the above examples, the content selection module 275 may select one or more content items having the highest rankings for presentation to the viewing user. The functionality of the content selection module 275 is further described below in conjunction with FIG. 3.

The web server 280 links the online system 140 via the network 120 to the one or more client devices 110, as well as to the third-party system 130 and/or one or more third-party systems 130. The web server 280 serves web pages, as well as other content, such as JAVA®, FLASH®, XML and so forth. The web server 280 may receive and route messages between the online system 140 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 210. Additionally, the web server 280 may provide application programming interface (API) functionality to send data directly to native client device operating systems, such as IOS®, ANDROID™, WEBOS® or BlackberryOS.

Managing a Frequency of Presentation of a Content Item Associated with a Category within a Hierarchical Taxonomy to an Online System User

FIG. 3 is a flow chart of a method for managing a frequency of presentation of a content item associated with a category within a hierarchical taxonomy to a user of an online system. In other embodiments, the method may include different and/or additional steps than those shown in FIG. 3. Additionally, steps of the method may be performed in a different order than the order described in conjunction with FIG. 3.

The online system 140 may receive 300 one or more content items from a content-providing user of the online system 140. For example, the online system 140 may receive 300 an advertisement from an advertiser or other content-providing user of the online system 140. A content item may include various elements, including a title, an image, a video, text, a call to action (e.g., to click on the content item), a link to a landing page associated with the content item (e.g., a brand page at which a purchase associated with the content item may be made), etc.

Each content item may be received 300 in conjunction with various types of information. A content item also may be received 300 in conjunction with targeting criteria describing online system users who are eligible to be presented with the content item (e.g., geographic locations associated with the online system users), advertising campaigns associated with the content items, etc. For example, targeting criteria received in conjunction with a content item are used to identify online system users associated with a particular type of client device 110, online system users who are using a particular browser, and online system users in a particular geographic location (e.g., based on GPS coordinates of a client device 110 associated with the users) as online system users who are eligible to be presented with the content item. As an additional example, information received in conjunction with an advertisement may describe an advertising campaign associated with the advertisement.

The online system 140 may store 302 each content item received 300 from a content-providing user of the online system 140 (e.g., in the content store 210). In some embodiments, the online system 140 may store 302 a content item in association with various types of information associated with the content item. For example, the online system 140 may store 302 a content item in the content store 210 in association with information identifying a content-providing user from whom the content item was received 300. In the above example, the online system 140 also may store 302 the content item in association with targeting criteria identifying attributes of online system users who are eligible to be presented with the content item. As an additional example, if a content item is an advertisement, the online system 140 may store 302 the content item in association with information identifying an advertiser from whom the content item was received 300 and an advertising campaign associated with the advertisement.

The online system 140 also may receive 304 information describing a hierarchical taxonomy from the content-providing user of the online system 140. Information describing the hierarchical taxonomy may be received 304 from the content-providing user via various means. For example, the online system 140 may receive 304 information describing a hierarchical taxonomy from a content-providing user of the online system 140 manually (e.g., in a PDF file). As an additional example, the online system 140 may receive 304 information describing a hierarchical taxonomy from a content-providing user via a user interface or an application programming interface.

Information describing the hierarchical taxonomy may describe various levels of the hierarchical taxonomy. For example, information describing a hierarchical taxonomy may indicate a number of levels included in the hierarchical taxonomy. Levels of the hierarchical taxonomy may be arranged in order of increasing specificity. In the above example, the information describing the hierarchical taxonomy also may indicate that a highest level of the hierarchical taxonomy includes the broadest categories and that each lower level of the hierarchical taxonomy includes increasingly specific categories, such that a lowest level of the hierarchical taxonomy includes the most specific categories.

Information describing the hierarchical taxonomy also may describe one or more categories included in each level of the hierarchical taxonomy. For example, information describing a hierarchical taxonomy may indicate a number of categories included in each level of the hierarchical taxonomy and a name or other identifier associated with each category. Furthermore, information describing each category within the hierarchical taxonomy may describe a set of more specific subcategories within a more specific level of the hierarchical taxonomy.

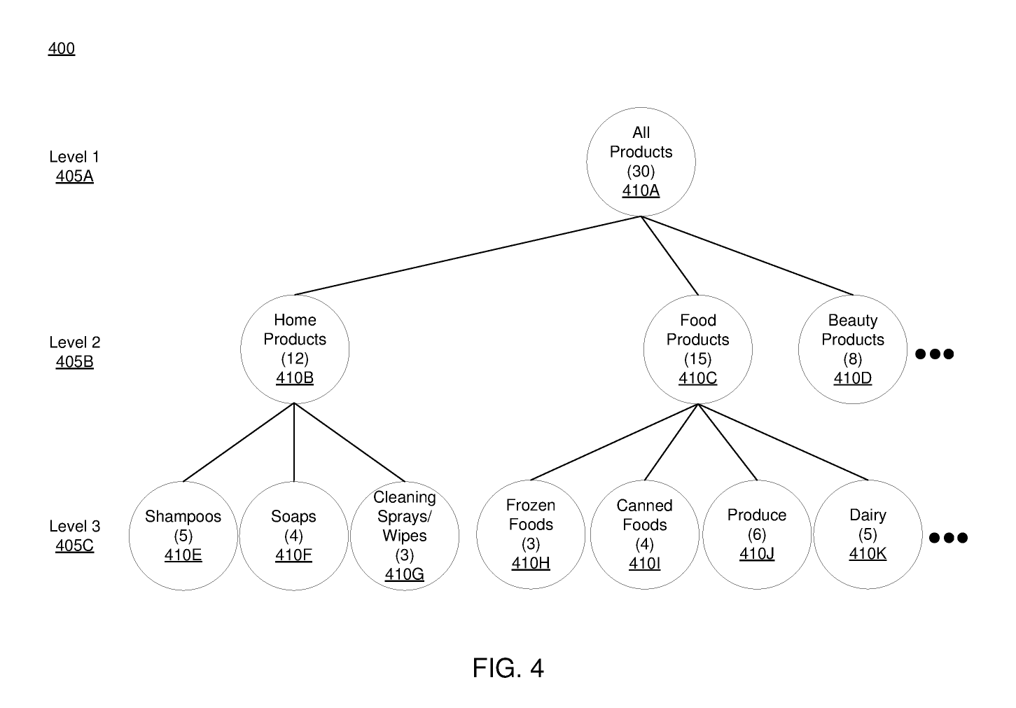

As illustrated in the example of FIG. 4, suppose that a content-providing user of the online system 140 from whom the online system 140 has received 304 information describing a hierarchical taxonomy 400 is an entity, such as a consumer goods corporation that owns several brands of different types of products. In this example, the hierarchical taxonomy 400 may have a highest level 405A that includes a broadest category 410A that may be associated with all of the corporation's products. Furthermore, in this example, the broadest category 410A may include a set of categories 410B-D within a lower level 405B of the hierarchical taxonomy 400, in which each category 410B-D may be associated with a more specific type of the corporation's products (e.g., home products 410B, food products 410C, beauty products 410D, etc.). Continuing with this example, each category 410B-D within the lower level 405B also may include a set of even more specific subcategories 410E-K within an even lower level 405C of the hierarchical taxonomy 400, in which each subcategory 410E-K may be associated with even more specific types of the corporation's products. For example, the home products category 410B includes subcategories associated with different types of home products, such as shampoos 410E, soaps 410F, and cleaning sprays/wipes 410G. As an additional example, the food products category 410C includes subcategories associated with different types of food products, such as frozen foods 410H, canned foods 410I, produce 410J, and dairy 410K.

Referring back to FIG. 3, the online system 140 may store 306 the information describing the hierarchical taxonomy received 304 from the content-providing user (e.g., in the taxonomy store 230). The online system 140 may store 306 various types of information describing the hierarchical taxonomy (e.g., information describing a structure of the hierarchical taxonomy, information identifying each level and each category within the hierarchical taxonomy, an organization of the levels relative to each other, etc.). For example, the online system 140 may store 306 information describing a number of levels of a hierarchical taxonomy, a number of categories within each of the levels, and a name assigned to each category by a content-providing user from whom the information was received 304.

In some embodiments, the online system 140 may store 306 information describing the hierarchical taxonomy in association with various additional types of information associated with the hierarchical taxonomy. Information associated with the hierarchical taxonomy that may be stored 306 in association with information describing the hierarchical taxonomy may include information identifying the content-providing user of the online system 140 from whom the information describing the hierarchical taxonomy was received 304, a date and a time at which the information was received 304, information identifying the hierarchical taxonomy, etc. For example, information describing a hierarchical taxonomy received 304 from a content-providing user may be stored 306 in the taxonomy store 230 in association with a username of the content-providing user, a name or other unique identifier assigned to the hierarchical taxonomy by the content-providing user or by the online system 140, and a date and a time that the information was received 304.

In some embodiments, the online system 140 may store 306 information describing updates or modifications to the hierarchical taxonomy. For example, suppose that a content-providing user of the online system 140 from whom the online system 140 has received 304 information describing a hierarchical taxonomy is an advertiser. In this example, if different categories included in a most specific level of the hierarchical taxonomy are associated with different advertising campaigns, the content-providing user may modify the hierarchical taxonomy by adding categories associated with new advertising campaigns and deleting categories associated with old advertising campaigns. Continuing with this example, information describing the previous version of the hierarchical taxonomy may be replaced by information describing the updated version of the hierarchical taxonomy (e.g., in the taxonomy store 230). Alternatively, in the above example, the information describing the previous version of the hierarchical taxonomy and the updated version of the hierarchical taxonomy both may be stored 306 in the online system 140, such that the information describing each version of the hierarchical taxonomy may be stored 306 in association with a date and a time that it was received 304 from the content-providing user.

In some embodiments, after the online system 140 has received 304 information describing the hierarchical taxonomy from the content-providing user of the online system 140, the online system 140 may organize the content items also received 300 from the content-providing user by assigning 308 (e.g., using the category assignment module 235) them to one or more categories included in a most specific level of the hierarchical taxonomy. For example, suppose that the online system 140 receives (step 300) advertisements associated with various advertising campaigns from a content-providing user of the online system 140 who is an advertiser. In this example, if information received 304 from the content-providing user indicates that categories included in a most specific level (e.g., a lowest level) of a hierarchical taxonomy are associated with different advertising campaigns, the online system 140 may assign 308 each advertisement received 300 from the content-providing user to a category associated with an advertising campaign with which the advertisement is associated. In the above example, the online system 140 may assign 308 the advertisements to the categories based on metadata associated with each advertisement identifying an advertising campaign associated with the advertisement and information stored 306 in association with the hierarchical taxonomy (e.g., in the taxonomy store 230) identifying an advertising campaign associated with each category.

In alternative embodiments, the content-providing user from whom the content items were received 300 may assign 308 the content items to one or more categories of the hierarchical taxonomy. For example, suppose that the online system 140 receives (step 300) multiple advertisements and information describing a hierarchical taxonomy from a content-providing user of the online system 140, in which categories included in the hierarchical taxonomy are associated with different advertising campaigns. In this example, the content-providing user may assign 308 each advertisement to a category associated with an advertising campaign with which the advertisement is associated and provide information describing the assignments to the online system 140.

Once the content items received 300 from the content-providing user of the online system 140 have been assigned 308 to the categories, the online system 140 may store 310 information describing the assignments of the content items to the categories (e.g., in the taxonomy store 230). For example, information describing a hierarchical taxonomy and information identifying one or more advertisements assigned 308 to categories within the hierarchical taxonomy may be stored 306, 310 in the taxonomy store 230.

In various embodiments, once the content items received 300 from the content-providing user of the online system 140 have been assigned 308 to the categories within the hierarchical taxonomy, the online system 140 also may store information describing associations between the content items and the categories within the hierarchical taxonomy (e.g., in the taxonomy store 230). In such embodiments, a content item that is assigned 308 to a category within the hierarchical taxonomy may be associated with multiple categories of the hierarchical taxonomy (e.g., the category to which it is assigned 308, as well as each broader category that includes the category to which the content item is assigned 308). For example, if a content item is assigned 308 to a first category included in a most specific level of a hierarchical taxonomy, the content item may be associated with the first category, as well as a second category included in a broader level of the hierarchical taxonomy that includes the first category. In this example, the content item also may be associated with a third category included in an even broader level of the hierarchical taxonomy that includes the second category, etc. In the above example, information describing the associations between the content item and each of the categories may be stored in the taxonomy store 230 in association with information describing the hierarchical taxonomy.

In some embodiments, the online system 140 may store information describing associations between the content items and the categories within the hierarchical taxonomy in association with objects representing the content items (e.g., in the content store 210). For example, an object representing a content item may be stored 302 in the content store 210 in association with an identifier associated with a hierarchical taxonomy and the names of one or more categories within the hierarchical taxonomy that are associated with the content item (e.g., a category to which the content item is assigned 308 and one or more broader categories that include this category).

The online system 140 may determine 312 (e.g., using the frequency determination module 245) one or more frequency caps to be applied to one or more categories of the hierarchical taxonomy. Frequency caps applied to categories of the hierarchical taxonomy allow the content-providing user of the online system 140 from whom the information describing the hierarchical taxonomy was received 304 to manage the presentation of the content items they have provided to the online system 140. A frequency cap applied to a category may correspond to a maximum number of impressions of one or more content items associated with the category that may be achieved within a specified time period for each viewing user of the online system 140, a maximum number of installations of an application associated with one or more content items associated with the category that may occur within a specified time period for each viewing user of the online system 140, or any other suitable limitation that may be applied to one or more content items associated with a category.

Frequency caps may be applied to multiple categories included in different levels of the hierarchical taxonomy. For example, suppose that the online system 140 has received (steps 300 and 304) multiple content items associated with repair services from a content-providing user of the online system 140, as well as information describing a hierarchical taxonomy, in which a broadest level of the hierarchical taxonomy includes a repair services category that may be associated with all of the content items received 300 from the content-providing user. In this example, the repair services category may include four subcategories of repair services (e.g., roofing repair services, plumbing repair services, electrical repair services, and heating/cooling repair services) that are included in a more specific level of the hierarchical taxonomy. In the above example, a frequency cap of 13 impressions per week may be applied to the repair services category, a frequency cap of five impressions per week may be applied to the roofing repair services subcategory, a frequency cap of six impressions per week may be applied to the plumbing repair services subcategory, a frequency cap of three impressions per week may be applied to the electrical repair services subcategory, and a frequency cap of five impressions per week may be applied to the heating/cooling repair services subcategory. Alternatively, in the above example, a default frequency cap of 19 impressions per week may be applied to the repair services category (e.g., based on a sum of the frequency caps applied to the four subcategories).

As an additional example, in the hierarchical taxonomy 400 illustrated in FIG. 4, a frequency cap corresponding to a maximum number of impressions per week is indicated in parentheses, such that a frequency cap of 30 impressions per week is applied to the broadest category 410A that may be associated with all of the corporation's products, a frequency cap of 12 impressions per week is applied to the home products category 410B, a frequency cap of 15 impressions per week is applied to the food products category 410C, and a frequency cap of eight impressions per week is applied to the beauty products category 410D. Similarly, a frequency cap of five impressions per week is applied to the shampoos subcategory 410E, a frequency cap of four impressions per week is applied to the soaps subcategory 410F, etc.

In some embodiments, the online system 140 may determine 312 a frequency cap to be applied to a category within the hierarchical taxonomy based at least in part on a graph generated (e.g., using the user interface module 240) based on historical data associated with one or more content items associated with the category that previously were presented to viewing users of the online system 140 (e.g., previous impressions of content items, previous clicks on content items, previous installations of applications associated with content items, etc.). In such embodiments, once the online system 140 has generated the graph, the online system 140 may determine 312 a frequency cap to be applied to a category within the hierarchical taxonomy based at least in part on the graph. For example, the online system 140 may generate a graph that plots a return on investment for impressions of content items associated with a category as a function of a number of impressions achieved by the content items. In this example, the online system 140 may determine 312 a frequency cap associated with the category that corresponds to the number of impressions achieved by the content items at which the return on investment begins to level off. In alternative embodiments, a frequency cap to be applied to a category within the hierarchical taxonomy may be determined 312 by the content-providing user of the online system 140. As an alternative to the above example, the online system 140 may present the graph to a content-providing user from whom the content items were received 300 and allow the content-providing user to specify a frequency cap to be applied to the category based on the graph. As an additional example, if the online system 140 receives 304 information describing a hierarchical taxonomy from a content-providing user of the online system 140, the online system 140 also may receive information describing one or more frequency caps specified by the content-providing user to be applied to one or more categories within the hierarchical taxonomy.

Referring again to FIG. 3, once the online system 140 has determined 312 or received one or more frequency caps to be applied to one or more categories of the hierarchical taxonomy, the online system 140 may store 314 information describing the frequency cap to be applied to each category. In some embodiments, information describing a frequency cap to be applied to a category within a hierarchical taxonomy may be stored 314 in association with information describing the hierarchical taxonomy (e.g., in the taxonomy store 230). For example, information describing a hierarchical taxonomy received 304 from a content-providing user may be stored 306 in the taxonomy store 230 in association with a username of the content-providing user, a name assigned to the hierarchical taxonomy by the content-providing user, and a frequency cap to be applied to each category. In various embodiments, information describing a frequency cap to be applied to a category within a hierarchical taxonomy also or alternatively may be stored 314 in association with an object representing each content item associated with the category (e.g., in the content store 210). For example, an object representing a content item may be stored 302 in the content store 210 in association with information describing a frequency cap to be applied to each of the categories associated with the content item.

The online system 140 may identify 316 an opportunity to present content to a viewing user of the online system 140. For example, the online system 140 may identify 316 an opportunity to present content to a viewing user of the online system 140 upon receiving a request from the viewing user to access a user profile page associated with the viewing user, in which the user profile page includes a newsfeed in which various content items may be presented. As an additional example, the online system 140 may identify 316 an opportunity to present content to a viewing user of the online system 140 upon receiving a request to present a web page maintained in the online system 140 to the viewing user, in which the web page includes a scrollable unit in which advertisements and other types of content items may be presented.

In some embodiments, upon identifying 316 an opportunity to present content to the viewing user, the online system 140 may determine 318 (e.g., using the frequency control module 250) whether to reset one or more counts describing the viewing user's progress towards one or more frequency caps applied to categories within the hierarchical taxonomy. Each count describing the viewing user's progress towards a frequency cap applied to a category within the hierarchical taxonomy may be associated with the category and the viewing user. For example, if a frequency cap corresponds to a maximum number of impressions of content items associated with a category that may be achieved within a day, a viewing user's progress towards the frequency cap may be stored in the user profile store 205 as a daily count. In this example, a value stored in the daily count corresponds to a number of impressions of content items associated with the category that have been achieved during the same day for the viewing user. A count may be stored in association with user-identifying information for the viewing user and a category associated with the count. For example, if a count tracks a viewing user's progress towards a frequency cap applied to a category within a hierarchical taxonomy, the count may be stored in the user profile store 205 in association with a user profile of the viewing user and an identifier that uniquely identifies the hierarchical taxonomy and the category within the hierarchical taxonomy.

In some embodiments, the online system 140 may determine 318 whether to reset a count associated with a category and the viewing user based on whether an amount of time specified by a frequency cap applied to the category has elapsed. For example, suppose that a frequency cap applied to a category describes a specified number of impressions of content items associated with the category that may be achieved within a week for each viewing user of the online system 140. In this example, a weekly count associated with the category may be stored in association with a user profile of a viewing user in the user profile store 205 that describes a progress of the viewing user towards the frequency cap. Continuing with this example, since the frequency cap specifies a maximum number of impressions per week, if the week began at 12:00 AM on a Sunday, at the end of the week (e.g., at 12:00 AM on the following Sunday), the online system 140 may determine 318 that the weekly count associated with the category and the viewing user should be reset. In the above example, prior to the end of the week, the online system 140 may determine 318 that the weekly count associated with the category and the viewing user should not be reset. Alternatively, in the above example, the online system 140 may determine 318 that the weekly count should be reset only after a week has elapsed from the time that the count was incremented from zero to one.

Responsive to determining 318 that one or more counts associated with the viewing user and one or more categories within the hierarchical taxonomy should be reset, the online system 140 may reset 320 (e.g., using the frequency control module 250) the counts. For example, upon determining 318 that a count associated with a category and a viewing user should be reset 320, the online system 140 may reset 320 the count to zero. In contrast, responsive to determining 318 that one or more counts associated with the viewing user and one or more categories within the hierarchical taxonomy should not be reset 320, the online system 140 may skip to step 326, described below.

If the online system 140 resets 320 the counts associated with one or more categories and the viewing user, the online system 140 also may determine 322 (e.g., using the exclusion group removal module 265) whether to remove the viewing user from exclusion groups associated with the categories. Viewing users included in an exclusion group associated with a category are not eligible to be presented with content items associated with the category (e.g., content items assigned 308 to the category and/or content items assigned 308 to one or more subcategories included in the category). For example, if a viewing user is included in an exclusion group associated with a category to which content items are assigned 308, the viewing user is not eligible to be presented with the content items. Alternatively, in the above example, if the category includes multiple subcategories to which content items are assigned 308, the viewing user is not eligible to be presented with the content items assigned 308 to the subcategories. In some embodiments, the viewing user is included in an exclusion group associated with a category within the hierarchical taxonomy if user-identifying information for the viewing user is included in a list maintained in the online system 140 (e.g., in the exclusion group store 255) that corresponds to an exclusion group associated with the category. For example, suppose a list associated with each category within a hierarchical taxonomy is stored in the exclusion group store 255. In this example, a viewing user of the online system 140 is included in an exclusion group associated with a category if user-identifying information for the viewing user is included in a list corresponding to the exclusion group associated with the category.

In various embodiments, the online system 140 may determine 322 whether to remove the viewing user from an exclusion group based on whether an amount of time specified by a frequency cap applied to the category has elapsed. For example, suppose that a frequency cap associated with a category describes a specified number of impressions of content items associated with the category that may be achieved within 30 days. In this example, suppose that a 30-day count stored in association with a user profile of a viewing user in the user profile store 205 describing a progress of the viewing user towards the frequency cap indicates that the viewing user has reached the frequency cap associated with the category and that the online system 140 previously included (e.g., using the exclusion group addition module 260) the viewing user in an exclusion group associated with the category. Continuing with this example, if the 30 days began at 12:00 AM on the first day of a month, at the end of the 30 days (e.g., at 12:00 AM on the 31^{st} day), the online system 140 may determine 322 that the viewing user should be removed from the exclusion group. Conversely, in this example, prior to the end of the 30 days, the online system 140 may determine 322 that the viewing user should not be removed from the exclusion group. Alternatively, in the above example, the online system 140 may determine 322 that the viewing user should be removed from the exclusion group only after 30 days have elapsed from the time that the 30-day count was incremented from zero to one.

In alternative embodiments, the online system 140 may determine 322 whether to remove the viewing user from an exclusion group associated with a category based on the progress of the viewing user towards a frequency cap applied to the category. For example, if a viewing user of the online system 140 is included in an exclusion group associated with a category, the online system 140 may periodically compare a count maintained in the online system 140 associated with the viewing user and the category to a value specified by a frequency cap applied to the category. In this example, the online system 140 may determine 322 that the viewing user should be removed from the exclusion group associated with the viewing user and the category if the count is less than the value specified by the frequency cap applied to the category. In contrast, in the above example, the online system 140 may determine 322 that the viewing user should not be removed from the exclusion group associated with the viewing user and the category if the count is equal to or greater than the value specified by the frequency cap applied to the category. As an additional example, the online system 140 may determine 322 that a viewing user of the online system 140 should be removed from an exclusion group associated with a category only when the online system 140 resets 320 a count maintained in the online system 140 associated with the viewing user and the category.

Responsive to determining 322 that the viewing user should be removed from one or more exclusion groups associated with one or more categories, the online system 140 may remove 324 (e.g., using the exclusion group removal module 265) the viewing user from the exclusion groups. The online system 140 may remove 324 the viewing user from an exclusion group associated with a category by removing user-identifying information for the viewing user (e.g., a username or a user identification number) from a list maintained in the online system 140 that corresponds to the exclusion group associated with the category (e.g., in the exclusion group store 255). For example, suppose that a viewing user of the online system 140 is included in an exclusion group associated with a category within a hierarchical taxonomy. In this example, if a count is maintained in the online system 140 to track the progress of the viewing user towards a frequency cap applied to the category, once the count is less than a value specified by the frequency cap, the online system 140 may remove 324 the viewing user from the exclusion group by removing user-identifying information for the viewing user from a list corresponding to the exclusion group associated with the category maintained in the exclusion group store 255. In contrast, responsive to determining 322 that the viewing user should not be removed 324 from one or more exclusion groups associated with one or more categories, the online system 140 may skip to step 326, described below.

The online system 140 may determine 326 (e.g., using the category determination module 270) if the viewing user is included in one or more exclusion groups associated with one or more categories within the hierarchical taxonomy. In some embodiments, the online system 140 may determine 326 whether the viewing user is included in an exclusion group associated with a category based on whether user-identifying information for the viewing user is included in a list maintained in the online system 140 (e.g., in the exclusion group store 255) that corresponds to the exclusion group associated with the category. For example, the online system 140 may access the exclusion group store 255 and determine 326 whether a viewing user of the online system 140 is included in an exclusion group associated with a category based on whether user-identifying information for the viewing user is included in a list corresponding to the exclusion group associated with the category. In this example, the online system 140 may determine 326 that the viewing user is included in the exclusion group if user-identifying information for the viewing user is included in the list corresponding to the exclusion group associated with the category. Conversely, in this example, the online system 140 may determine 326 that the viewing user is not included in the exclusion group if user-identifying information for the viewing user is not included in the list corresponding to the exclusion group associated with the category.

In some embodiments, the online system 140 may determine 326 whether the viewing user is included in exclusion groups associated with categories included in different levels of the hierarchical taxonomy. For example, the online system 140 may determine 326 that a viewing user is not included in any exclusion groups associated with one or more categories within a hierarchical taxonomy, in which none of the categories are included in broader categories within the hierarchical taxonomy that are associated with exclusion groups that include the viewing user. In such embodiments, the online system 140 may determine 326 whether the viewing user is included in exclusion groups associated with categories of the hierarchical taxonomy by examining the exclusion groups associated with the broadest categories first, by examining the exclusion groups associated with the most specific categories first, or by examining exclusion groups associated with categories in any other suitable order.

In some embodiments, once the online system 140 has determined 326 that the viewing user is not included in one or more exclusion groups associated with one or more categories within the hierarchical taxonomy, the online system 140 may then identify 328 (e.g., using the content selection module 275) a set of content items associated with the categories as candidate content items that are eligible for presentation to the viewing user. For example, the online system 140 may access the taxonomy store 230 or the content store 210 and identify 328 all content items associated with categories that are not associated with exclusion groups that include a viewing user as candidate content items eligible to be presented to the viewing user. In various embodiments, the online system 140 may identify 328 the set of candidate content items based on additional factors as well (e.g., targeting criteria specifying attributes for online system users eligible to be presented with the content items). For example, once the online system 140 has determined 326 that a viewing user of the online system 140 is not included in one or more exclusion groups associated with one or more categories within a hierarchical taxonomy, the online system 140 may identify 328 only content items associated with the categories that are associated with targeting criteria (e.g., age, gender, geographic location, etc.) satisfied by the viewing user as candidate content items.

In alternative embodiments, the online system 140 may perform the steps described above in a different order. For example, the online system 140 may first identify one or more content items that are associated with targeting criteria that are satisfied by a viewing user. In this example, for each content item identified by the online system 140, the online system 140 may determine 326 whether the viewing user is included in an exclusion group associated with a category with which the content item is associated. Continuing with the above example, if the viewing user is not included in the exclusion group associated with the category, the online system 140 may identify 328 the content item associated with the category to be a candidate content item eligible to be presented to the viewing user.

Once the online system 140 has identified 328 a set of candidate content items eligible to be presented to the viewing user, the online system 140 may select 330 (e.g., using the content selection module 275) one or more of the candidate content items for presentation to the viewing user. In some embodiments, the online system 140 may rank the candidate content items based at least in part on a value associated with each candidate content item and select 330 one or more content items for presentation to the viewing user based at least in part on the ranking. For example, the online system 140 may rank the candidate content items based at least in part on an affinity score computed by the online system 140 indicating a predicted affinity of a viewing user for the candidate content item, in which candidate content items having higher affinity scores are ranked higher than candidate content items having lower affinity scores. In this example, if one or more of the candidate content items are advertisements, the online system 140 also or alternatively may rank the candidate content items based at least in part on a bid amount associated with each advertisement, in which advertisements associated with higher bid amounts are ranked higher than advertisements associated with lower bid amounts. In the above examples, the online system 140 may select 330 one or more content items having the highest rankings for presentation to the viewing user.

The online system 140 may generate 332 (e.g., using the user interface module 240) a user interface in which the content items selected 330 for presentation to the viewing user of the online system 140 may be presented. In some embodiments, the user interface generated 332 by the online system 140 may include a feed of content items that includes one or more content items selected 330 for presentation to the viewing user. For example, the online system 140 may generate 332 a newsfeed associated with a user profile of a viewing user of the online system 140. In this example, the newsfeed may include multiple content items (e.g., advertisements) selected 330 for presentation to the viewing user. The user interface generated 332 by the online system 140 may include a set of interactive elements (e.g., buttons) that each correspond to an option associated with a content item that may be selected by the viewing user. Examples of options associated with a content item that may be selected by the viewing user include an option to express a preference for a content item, an option to share the content item with additional online system users, and an option to comment on the content item. For example, if a viewing user of the online system 140 selects an option to share a content item presented to the viewing user, the content item may be presented to additional users of the online system 140 to whom the viewing user is connected in the online system 140.

Once the online system 140 has selected 330 one or more content items for presentation to the viewing user of the online system 140, the online system 140 may present 334 the content items to the viewing user. For example, if the online system 140 generates 332 a newsfeed including one or more content items selected 330 for presentation to a viewing user of the online system 140, the online system 140 may present 334 the newsfeed to the viewing user by sending the newsfeed to a client device 110 (e.g., a mobile phone or a desktop computer) used by the viewing user to access a web page for the online system 140.

The online system 140 may increment 336 (e.g., using the frequency control module 250) one or more counts associated with the categories associated with the viewing user and the content items presented 334 to the viewing user. As described above, the online system 140 may track the progress of the viewing user towards a frequency cap applied to a category by maintaining a count that is associated with the category and the viewing user. In some embodiments, the online system 140 may increment 336 a count associated with a category and a viewing user upon each presentation of a content item associated with the category to the viewing user. For example, if a frequency cap of three impressions per week is applied to a category within a hierarchical taxonomy, the online system 140 may maintain a weekly count of the number of impressions achieved by content items assigned 308 to the category for each viewing user of the online system 140 (e.g., stored in the user profile store 205 in association with a user profile of the viewing user). In this example, when a first impression of a content item assigned 308 to the category is achieved, the online system 140 may increment 336 a weekly count maintained in the online system 140 that is associated with the category and the viewing user from zero to one. Continuing with this example, when a second impression of a content item assigned 308 to the category is achieved for the viewing user, the online system 140 may increment 336 the count from one to two, etc.

In various embodiments, if a content item presented 334 to the viewing user is associated with multiple categories in a hierarchical taxonomy to which frequency caps have been applied, the online system 140 may track the progress of the viewing user towards a frequency cap applied to each category. For example, suppose that a frequency cap of five impressions per week is applied to a first category within a hierarchical taxonomy and that an additional frequency cap of six impressions per week is applied to a second category that includes the first category. In this example, in response to each impression achieved by a content item assigned 308 to the first category for a viewing user of the online system 140, in addition to incrementing 336 a weekly count maintained in the online system 140 that is associated with the viewing user and the first category, the online system 140 also may increment 336 a weekly count maintained in the online system 140 that is associated with the viewing user and the second category.

The online system 140 may determine 338 (e.g., using the exclusion group addition module 260) whether to include the viewing user in one or more exclusion groups. The online system 140 may determine 338 that the viewing user should be included in an exclusion group associated with a category if the viewing user reaches a frequency cap applied to the category. In some embodiments, the online system 140 may determine 338 whether to include the viewing user in an exclusion group associated with a category by comparing a count associated with the category and the viewing user to a value specified by a frequency cap applied to the category. For example, if a frequency cap of 30 impressions per month is applied to a category and the online system 140 increments 336 a monthly count of the number of impressions achieved by content items assigned 308 to the category maintained for a viewing user, the online system 140 may compare the monthly count to a value specified by the frequency cap. In this example, the online system 140 may determine 338 that the viewing user should be included in an exclusion group associated with the category if the monthly count is at least 30. Conversely, in this example, the online system 140 may determine 338 that the viewing user should not be included in an exclusion group associated with the category if the monthly count is less than 30.

Responsive to determining 338 that the viewing user should be included in one or more exclusion groups, the online system 140 may include 340 (e.g., using the exclusion group addition module 260) the viewing user in the exclusion groups. In some embodiments, the online system 140 may include 340 the viewing user in an exclusion group associated with a category by adding user-identifying information for the viewing user (e.g., a username or a user identification number) to a list maintained in the online system 140 that corresponds to the exclusion group associated with the category (e.g., in the exclusion group store 255). For example, if a frequency cap of two impressions per week is applied to a category within a hierarchical taxonomy, once a count maintained in the online system 140 that is associated with the category and a viewing user is incremented 336 to two, the online system 140 may add user-identifying information for the viewing user to a list of online system users corresponding to an exclusion group associated with the category maintained in the exclusion group store 255.

Responsive to determining 338 that the viewing user should not be included 340 in one or more exclusion groups or after including 340 the viewing user in the exclusion groups, the online system 140 may identify 316 another opportunity to present content to the viewing user and repeat some of the steps described above.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, a hierarchical taxonomy associated with a content-providing user of the online system, the hierarchical taxonomy comprising a plurality of levels arranged in order of increasing specificity, each level of the plurality of levels comprising a set of categories with which one or more content items received from the content-providing user are associated;
identifying an opportunity to present content to a viewing user of the online system;
determining whether the viewing user is included in one or more exclusion groups associated with one or more categories within the hierarchical taxonomy;
responsive to determining that the viewing user is not included in the one or more exclusion groups associated with the one or more categories, identifying a content item eligible for presentation to the viewing user, wherein the content item is associated with the one or more categories;
presenting the identified content item to the viewing user;
for each category of the one or more categories:
incrementing a count associated with the viewing user and a category of the one or more categories;
comparing the incremented count to a value specified by a frequency cap applied to the category; and
determining whether to include the viewing user in an exclusion group associated with the category based at least in part on the comparing.

2. The method of claim 1, further comprising:
including the viewing user in the exclusion group associated with the category responsive to determining that the incremented count is at least the value specified by the frequency cap.

3. The method of claim 1, further comprising:
not including the viewing user in the exclusion group associated with the category responsive to determining that the incremented count is less than the value specified by the frequency cap.

4. The method of claim 1, wherein the identified content item is assigned to a subcategory included in the one or more categories.

5. The method of claim 4, wherein the identified content item is assigned to the subcategory by the content-providing user of the online system or by the online system.

6. The method of claim 1, wherein the hierarchical taxonomy comprises at least a subcategory comprising a level of the plurality of levels and a broader category comprising an additional level of the plurality of levels, wherein the broader category includes the subcategory.

7. The method of claim 6, wherein determining whether the viewing user is included in one or more exclusion groups associated with one or more categories within the hierarchical taxonomy comprises:
determining whether the viewing user is included in a first exclusion group associated with the subcategory and a second exclusion group associated with the broader category that includes the subcategory.

8. The method of claim 7, wherein determining whether the viewing user is included in the first exclusion group associated with the subcategory and the second exclusion group associated with the broader category that includes the subcategory comprises:
determining whether user-identifying information for the viewing user is included in a list maintained in the online system that corresponds to the first exclusion group associated with the subcategory and an additional list maintained in the online system that corresponds to the second exclusion group associated with the broader category.

9. The method of claim 1, further comprising:
resetting the count associated with the viewing user and the category of the one or more categories to zero after a period of time has elapsed, wherein the period of time is specified by the frequency cap applied to the category.

10. The method of claim 1, wherein the frequency cap applied to the category comprises a maximum number of impressions of a set of content items associated with the category that may be achieved within a specified period of time.

11. The method of claim 1, further comprising:
determining the frequency cap applied to the category based at least in part on historical information associated with a set of content items associated with the category.

12. The method of claim 1, wherein the frequency cap applied to the category comprises a default frequency cap, the default frequency cap based at least in part on an additional frequency cap applied to a subcategory included in the category.

13. A computer program product comprising a computer readable storage medium having instructions encoded thereon that, when executed by a processor, cause the processor to:
receive, at an online system, a hierarchical taxonomy associated with a content-providing user of the online system, the hierarchical taxonomy comprising a plurality of levels arranged in order of increasing specificity, each level of the plurality of levels comprising a set of categories with which one or more content items received from the content-providing user are associated;
identify an opportunity to present content to a viewing user of the online system;
determining whether the viewing user is included in one or more exclusion groups associated with one or more categories within the hierarchical taxonomy;
responsive to determining that the viewing user is not included in the one or more exclusion groups associated with the one or more categories, identifying a content item eligible for presentation to the viewing user, wherein the content item is associated with the one or more categories;
present the identified content item to the viewing user;
for each category of the one or more categories:
increment a count associated with the viewing user and a category of the one or more categories;
compare the incremented count to a value specified by a frequency cap applied to the category; and
determine whether to include the viewing user in an exclusion group associated with the category based at least in part on the comparing.

14. The computer program product of claim 13, wherein the computer readable storage medium further has instructions encoded thereon that, when executed by the processor, cause the processor to:
include the viewing user in the exclusion group associated with the category responsive to determining that the incremented count is at least the value specified by the frequency cap.

15. The computer program product of claim 13, wherein the computer readable storage medium further has instructions encoded thereon that, when executed by the processor, cause the processor to:
not include the viewing user in the exclusion group associated with the category responsive to determining that the incremented count is less than the value specified by the frequency cap.

16. The computer program product of claim 13, wherein the identified content item is assigned to a subcategory included in the one or more categories.

17. The computer program product of claim 16, wherein the identified content item is assigned to the subcategory by the content-providing user of the online system or by the online system.

18. The computer program product of claim 13, wherein the hierarchical taxonomy comprises at least a subcategory comprising a level of the plurality of levels and a broader category comprising an additional level of the plurality of levels, wherein the broader category includes the subcategory.

19. The computer program product of claim 18, wherein determine whether the viewing user is included in one or more exclusion groups associated with one or more categories within the hierarchical taxonomy comprises:
determine whether the viewing user is included in a first exclusion group associated with the subcategory and a second exclusion group associated with the broader category that includes the subcategory.

20. The computer program product of claim 19, wherein determine whether the viewing user is included in the first exclusion group associated with the subcategory and the second exclusion group associated with the broader category that includes the subcategory comprises:
determine whether user-identifying information for the viewing user is included in a list maintained in the online system that corresponds to the first exclusion group associated with the subcategory and an additional list maintained in the online system that corresponds to the second exclusion group associated with the broader category.

21. The computer program product of claim 13, wherein the computer readable storage medium further has instructions encoded thereon that, when executed by the processor, cause the processor to:
reset the count associated with the viewing user and the category of the one or more categories to zero after a period of time has elapsed, wherein the period of time is specified by the frequency cap applied to the category.

22. The computer program product of claim 13, wherein the frequency cap applied to the category comprises a maximum number of impressions of a set of content items associated with the category that may be achieved within a specified period of time.

23. The computer program product of claim 13, wherein the computer readable storage medium further has instructions encoded thereon that, when executed by the processor, cause the processor to:
determine the frequency cap applied to the category based at least in part on historical information associated with a set of content items associated with the category.

24. The computer program product of claim 13, wherein the frequency cap applied to the category comprises a default frequency cap, the default frequency cap based at least in part on an additional frequency cap applied to a subcategory included in the category.

25. A method comprising:
identifying an opportunity to present content to a viewing user of an online system;
determining whether the viewing user is included in one or more exclusion groups associated with one or more categories within a hierarchical taxonomy;
responsive to determining that the viewing user is not included in the one or more exclusion groups associated with the one or more categories, identifying a content item eligible for presentation to the viewing user, wherein the content item is associated with the one or more categories;
presenting the identified content item to the viewing user;
for each category of the one or more categories:
incrementing a count associated with the viewing user and a category of the one or more categories; and
determining whether to include the viewing user in an exclusion group associated with the category based at least in part on the incremented count and a frequency cap applied to the category.
